(19) United States
(12) Patent Application Publication
(10) Pub. No.: US 2006/0242432 A1
(43) Pub. Date: Oct. 26, 2006

(54) E.MAGNUM

(76) Inventor: Ellisa Pearl Burks, Palmdale, CA (US)

Correspondence Address: Ellisa Pearl McKnight, 37635 Lasker Ave, Palmdale, CA, 93550, US

(21) Appl. No.: 11/002,500

(22) Filed: Apr. 25, 2005

(51) Int. Cl. G06F 12/14

(52) U.S. Cl. 713/194

(57) ABSTRACT

E.MAGNUM is a motion activated apparatus that detects and disables digital electronics it has a built in GENERATOR and a built in CHARGER. E.MAGNUM has a attachment called a Digital Electronic Body Detector that detects frequencies and energy. E.MAGNUM deletes the memory of the chip inside any digital electronic device. The apparatus detects energy present and records the level of frequencies to let you know the level of energy the higher the level of energy the bigger the threat is to the security operation. Some devices have a low level of frequency these are devices such as, cameras, radios and smaller digital electronics. The high level frequencies are devices such as, bombs. When baggage items travel through E.MAGNUM any digital electronic will be detected by the level of energy or frequencies generated from the device. When the apparatus deletes the memory from the chip inside the digital electronic this will cause the device to forget the next command therefore scrambling the guts and destroying the device. Safety instructions will be visible when entering the area of the security operation. E.MAGNUM scrambles memory in digital electronics the same way CELL PHONES affect hospital equipment or Airplane mechanics. The GENERATOR is built in for fail safe reasons such as, power outages. This will allow E.MAGNUM to operate in an environment without power. There are no known apparatuses like E.MAGNUM other than the METAL DECTOR the difference is E.MAGNUM detects and disables digital electronics. In doing my research there is very little if any study done on this field. The digital electronic body detector only detects energy or frequencies around the body it will not disable the device. All the functions of E.MAGNUM are necessary to guarantee maximum security and to assist in full quality use.

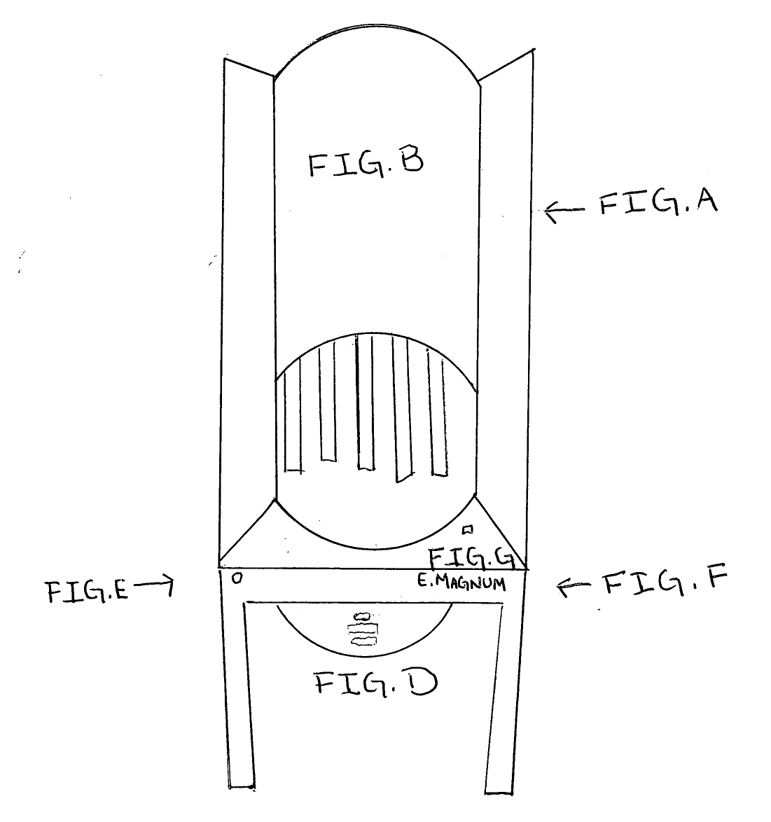

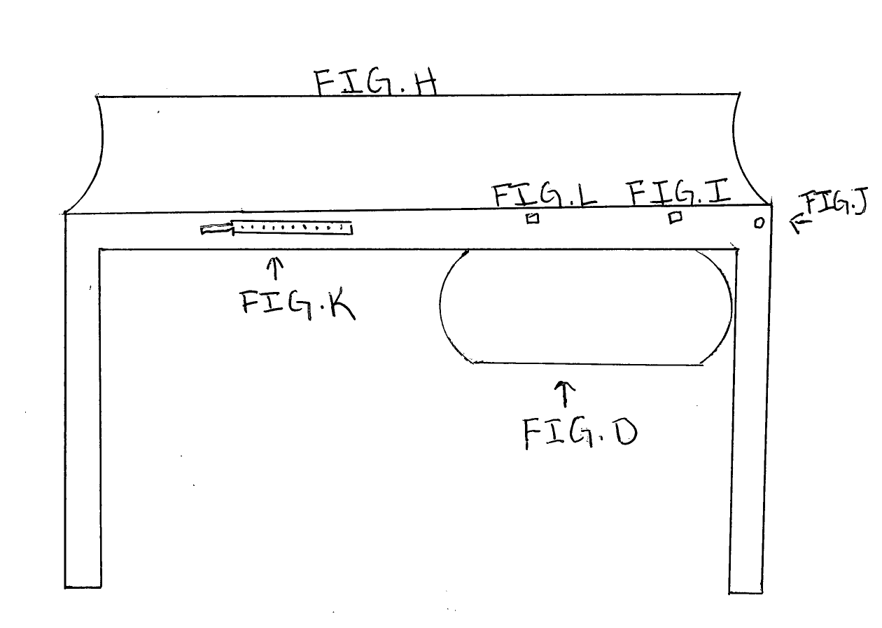

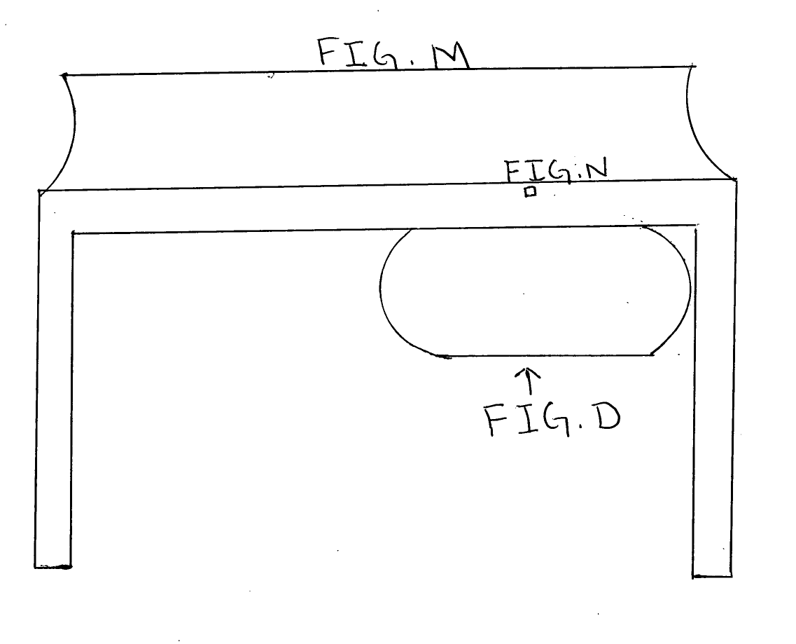

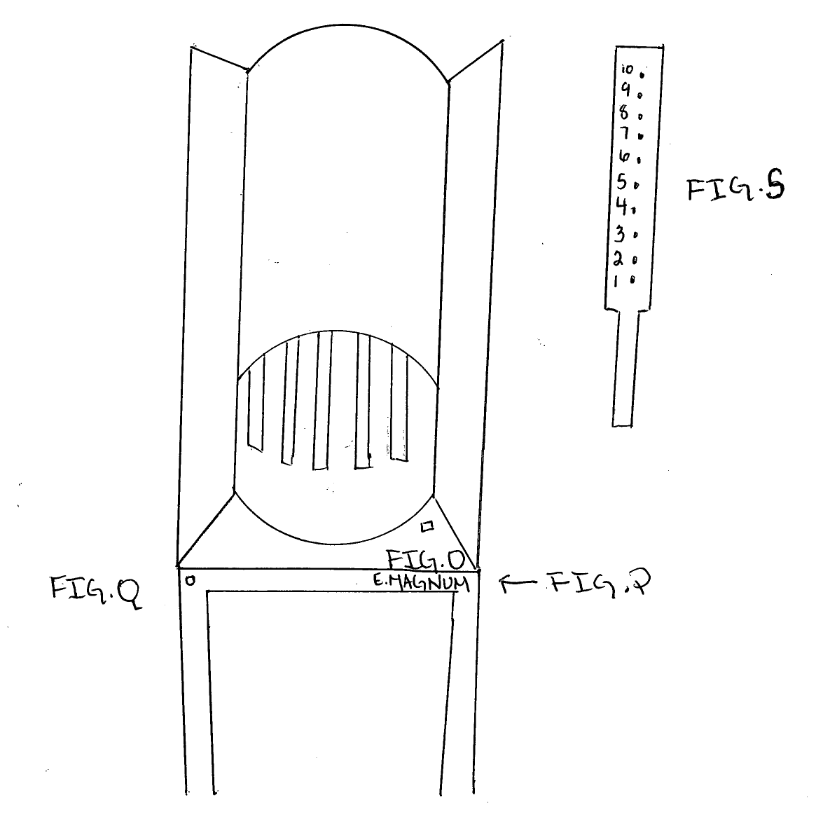

### FIELD OF INVENTION

This invention pertains to the field of security. The purpose of my invention is to detect and disable digital electronics. To my knowledge there is no prior research pertaining to my invention.

### BACKGROUND OF INVENTION

My initial thought for my invention was a motion activated terminal apparatus that drains the battery from battery operated devices. The background research for my invention was done on the internet. My research was done on the web site YAHOO!. My first search was on “How heat kills batteries”. This information helped me understand how different temperatures affect batteries. The title of the page was, “Design and Application tips to ensure maximum service and life”. The excessive charge voltage that forces and overcharge current into the battery which will dissipate as heat and cause gas. Within a short time this will curate the positive plate material and accelerate the battery towards end-of-life. I also searched on “How electricity works”, electrons are particles that orbit the nucleus of an atom, I also searched on a site called “What is a circuit”. A series allows electrons to flow in a path. I further searched on GOGGLE. I found a page on electromagnetic force fields. After doing the research on this idea I found it would be harmful to pace makers, hearing aids. The first sketch of E.MAGNUM was and upright unit that people walked through. I had to revise ray invention. It became as explained in the next paragraph. I also searched on, how to detect digital electronics”. It said no data found. I also searched on “how to disable digital electronics”. It also said no data found.

After presenting my invention to Innovative Patent Services which is a service that assist you with your patent applications. They approved my invention with a revision from a motion activated terminal apparatus that drains the batteries from battery operated devices to a motion activated terminal apparatus that disables digital electronics. They were even able to get me a $7,000.00 loan from a bank to finance my invention. We decided the unit would cost approximately $30,000.00 per unit my percentage was 5% per unit my take would only be $750.00 per unit plus the loan had a 1.1/2% interest rate which means I would have had to pay $750.00 per month starting in 45 days. I don't mink so.

The news was a good research tool also. Back in June 2004, I saw a segment on the news about someone getting caught recording a movie in a Hollywood theater. The manager was a odds as to what to do about this problem. So the next day he went out and purchased some night goggles to catch violators. People in the industry do not know what to do about the problem.

I received a some information from Janet Marshall, consultant a Innovative Patent Service about a Bill being passed that will make camcording a felony. The Hollywood reporter writes “Movie pirates beware. If you get caught camcording a movie you can get jail time”. The Bill has been approved by the House on Tuesday, (information received on Sep. 29, 2004). It is waiting to be signed by President Bush. The Piracy and Deterrence Act make camcording a felony punishable by three years for the first offense and six years in federal prison for the next offense. It also makes it easier for the justice department to prosecute internet users who illegally distribute large amounts of copyrighted works. It was approved on voice vote. “There seems to be a belief amongst youth . . . that copyright piracy is either an acceptable activity or one that carries low risk of penalties”, said Rep. James Sensenbrenner, R-Wis, chairman of the House of Judicial Committee. Passage of the Bill was praised by the motion picture industry, which fought for Bill along with the record industry. Today's actions by the House of Representatives will help thwart the widespread theft of Americans intellectual property, “Digital film piracy is a menace that poses a dire threat to American filmmakers”. H.R, 4077 will provide law enforcement the proper tool to go after the heart of film piracy: Illegal camcording of movies and the theft of film on peer-to-peer networks or on similar technologies. Without such legislative remedies, film piracy could have a disastrous impact on the American film industry and put to peril the livelihoods of men and women in our industry. About ten states already prohibit people from recording inside theaters. The House Bill will make it a felony. Under the legislation local and state police can make arrest even when they don't personally witness the illicit recording. The Bill will also makes it easier for the justice department to prosecute internet users who illegally distribute more than 1,000 copyright files. U.S. Law now requires prosecutors to prove that the internet user “Willfully” distributes music and movies files illegally. Some internet users have complained that they were unaware that by downloading files from these networks unto their computers, they also make the file available to others. Under the House Bill, prosecutors must prove internet users “Knowingly” distributed copyrighted materials with a “reckless disregard” that others also might copy them a much easier standard to prove. It also encourages FBI to ask interact providers to forward a warning letter to subscribers whose accounts are being used for illegally downloading music and movies. That provision is aimed largely at parents who might be unaware of their children's activities.

There has been no prior art pertaining to my if it is, it has proven to be ineffective. The film industry is losing billions of dollars every year to digital film piracy. Janet Marshall, consultant at Innovative Patent Services said, “This could change the world as we know it.” Kish Kuehernt, managing director of Innovative patent service says “I see these things in every airport in the world”.

The METAL DETECTOR detects metal. E.MAGNUM detects and disables digital electronics.

The GENERATOR is built in for fail safe reasons such as, power outages.

The CHARGER is built in to recharge the body detector.

The body detector can only detect frequencies or energy present on the body.

E. MAGNUM will be most useful in Movie Theaters, Airports, Federal Buildings, Hospitals, Bus Stations, Train Stations, and other facilities that handle baggage.

### SUMMARY

E.MAGNUM is a motion activated terminal apparatus that detects and disables digital electronics.

E.MAGNUM purpose is to secure baggage, purses, suitcases, and digital electronics that may be a threat to the security operation.

E.MAGNUM has attachments to assist in the security operation.

The GENERATOR is for fail safe reasons such as power outages.

The CHARGER is to recharge the body detector.

The body detector will detect frequencies or energy present on the body, but will not disable the device.

E.MAGNUM will be most useful in movie theaters, airports, federal buildings, hospitals, bus stations, train stations, and other public facility that handles baggage.

In comparison to the METAL DETECTOR. E.MAGNUM is a digital electronic defector. They both are used in security operations, bat E.MAGNUM is designed for the new Millennium,

### BRIEF DESCRIPTION OF DRAWINGS

FIG. A schematically illustrates the front view of the table of the apparatus.

FIG. B schematically illustrates the terminal or tunnel like baggage travels through,

FIG. C schematically illustrates the entrance to the terminal or tunnel also the rotating belt is visible from this view.

FIG. D schematically illustrates the placement of the GENERATOR.

FIG. E schematically illustrates the light to alert the apparatus is off

FIG. F schematically illustrates the name E.MAGNUM.

FIG. G schematically illustrates the on/off button push it once to shut the apparatus on and push it once more to shut it off. This button also is the button for the generator push it twice for the generator to come on, push it twice for it to shut off.

FIG. H schematically illustrates the left side view of the apparatus.

FIG. I schematically illustrates the stop button for the terminal in case of lodged items.

FIG. J schematically illustrate the generator light green is on.

FIG. K schematically illustrates the placement for the digital electronic detector and the CHARGER

FIG. L schematically illustrates the start button for the terminal to restart its rotating motion.

FIG. M schematically illustrates the right side of the apparatus.

FIG. N schematically illustrates the light to alert frequencies or energy when it is present. The light blinks red.

FIG. O schematically illustrates the on/off button for the back view of the apparatus.

FIG. P schematically illustrates the E.MAGNUM name.

FIG. Q schematically illustrates e on/off light to let you know the apparatus is on or off

FIG. R schematically illustrates the back view of the terminal or tunnel and the rubber strips for security.

FIG. S schematically illustrates e digital electronic body detector. The numbers represent the level of frequencies.

### DESCRIPTION OF PREFERRED EMBODIMENT

E.MAGNUM is a motion activated terminal apparatus that detects and disables digital electronics. E. MAGNUM has a built in GENERATOR and an built in CHARGER. The digital electronic body detector is to detect frequencies or energy present on the body.

Once the level of frequencies or energy are determined the apparatus will disable the device by deleting the memory or scrambling the gut of the electronic device.

For example, CELL PHONES scramble the memory in hospital equipment. That is why they have a do not use cell phone posted. The frequencies get crossed and the device forgets the next command.

The GENERATOR is useful in power outages.

The CHARGER is useful to recharge the attachment.

E. MAGNUM purpose is to detect and disable digital electronics that may be a threat to the security operation.

Although E.MAGNUM resembles the METAT DETECTOR their functions are for different purposes.

E.MAGNUM is a table style apparatus,

It stands approximately 3 to 4 feet tall Ft is approximately 3 to 5 feet long.

The front of the apparatus has a 3½ inch panel On the front you will see the generator at the bottom of the apparatus. The E.MAGNUM same is viable from the front view. The on/off light is also visible from the front view. You can also see the rotating belt and the security strips from the front view.

The legs on the apparatus are approximately 2½ inches wide.

The side view of the apparatus shows more buttons and instructions. Such as, “remove all digital electronics from your baggage”.

The back view you will see the E, MAGNUM name on the right corner. A on/off button above E.MAGNUM. The rubber secure strips are visible also.

While specific embodiments of the invention have been described for the purpose of illustration, it will be understood that the invention may be carried into practice by skilled persons with many modifications, variations and adaptations, without departing from its sprit or exceeding the scoop of the claim.

The Manufacture 1 may be using is named Intellect Lab Manufacturing Services. Their services are HW Engineering, SW Engineering, Manufacturing, Cable Design, Procurement and Outsourcing. They are located in Silicon, Calif.

What I claim my invention to be is:

1. A motion activated terminal apparatus that detects and disables digital electronics by deleting the memory or scrambling the gut of the device, E.MAGNUM also has a built in GENERATOR and a built in CHARGER. E. MAGNUM also has a attachment called a digital electronic body detector that detects frequencies or energy on the body, but will not disable the device.

2. In reference to claim 1, A motion activated terminal apparatus that disables digital electronics by deleting the memory or scrambling the gut of the device.

3. In reference to claim 1, A motion activated terminal that detects digital electronics by detecting frequencies or energy present.

4. In reference to claims 1-3, A non-motion activated terminal that detects and disables digital electronics by deleting the memory or scrambles the guts in the device. And a built in GENERATOR and a built in CHARGER. Also has an attachment called a digital electronic body detector that detect frequencies or energy on the body.

5. In reference to claim 4, A non-motion activated terminal apparatus that detects digital electronics by detecting frequencies or energy present

6. In reference to claim 4, a non-motion activated terminal that disables digital electronics by deleting the memory or scrambling me guts of the device.

7. In reference to claims 1-6, A hand held device that detects digital electronics called a Digital Electronic Body detector. This will only detect not disable.
